(19) United States
(12) Patent Application Publication
(10) Pub. No.: US 2022/0311280 A1
(43) Pub. Date: Sep. 29, 2022

(54) WIRELESS CHARGING OF BATTERIES OF ACCESSING DEVICES

(71) Applicant: Carrier Corporation, Palm Beach Gardens, FL (US)

(72) Inventors: Sumanth Kumar Mukundala, Hyderabad, Telangana (IN); Rajesh Athelly, Hyderabad, Telangana (IN); Vasudevan Raghavan, Hyderabad, Telangana (IN)

(21) Appl. No.: 17/254,606

(22) PCT Filed: Aug. 24, 2020
(86) PCT No.: PCT/IB2020/057899

§ 371 Date: Dec. 21, 2020

(30) Foreign Application Priority Data
Sep. 6, 2019 (IN) 2019 11036034

(51) Int. Cl. H02J 50/20; H02J 50/80; H02J 7/00; H02J 50/50

(52) U.S. Cl. CPC H02J 50/20; H02J 50/80; H02J 7/0048; H02J 50/50; G07C 2009/00642

(57) ABSTRACT

A method and an apparatus for wireless charging of batteries of electronic accessing devices. A method includes establishing a first connection between a battery of an accessing device and a receiver and a second connection between the accessing device and a transmitter, the transmitter and the receiver being associated with each other. The method further includes determining a charging status of the battery of the accessing device and communicating the charging status of the battery to the transmitter on determining that the charging status of the battery reaches below a predefined threshold value via the second connection. The method also includes charging the battery of the accessing device with power from the receiver using the first connection, wherein the receiver receives the power from the transmitter over the air.

### FOREIGN PRIORITY

This application is a 371 U.S. National Stage application of PCT/IB2020/057899, filed Aug. 24, 2020, which claims the benefit of Indian. Provisional Application No. 201911036034, filed Sep. 6, 2019, both of which are incorporated by reference in their entirety herein.

### TECHNICAL FIELD OF INVENTION

The present invention relates generally to electronic accessing devices. More particularly, the invention relates to a method and an apparatus for wireless charging of batteries of the electronic accessing devices.

### BACKGROUND OF THE INVENTION

Presently, electronic locking systems are powered by disposable batteries for carrying out lock operations. The batteries are generally non-rechargeable. The use of such non-rechargeable batteries poses a number of problems causing inconvenience to a user. For instance, if the power of the battery of the lock goes down below a threshold level or becomes dead, it hampers the lock operations. Then it may not be possible to open the lock to access a premises, vehicle or a locker. In case of low/dead batteries situations, technician may use Portable programmer (PP/XPP) to open the lock. Technician will use toolkits to dismantle locks/Key boxes to replace low/dead batteries. However, this method is cumbersome requiring effort on the part of the technician, and the user of the access device needs to wait for substantial time. The method may not be practically feasible if the number of locks in an establishment are high. Moreover, the user is troubled unnecessarily as he/she is unable to get timely access.

Similarly, there may be a possibility wherein the electronic lock (for example, Small Form Factor Lock or SFFL) may not have a socket at the door for attaching PP. In that case, the process of replacing the discharged batteries will entail removal of battery from the door directly. However, this is again a tedious process and may also damage the door.

Generally, the accessing devices are connected with other devices such as IoT devices TV, AC, RMS, Thermostat and the like. The accessing device or the lock may be coupled with a SFFL repeater which enables the expansion of communication between door lock and the IOT devices using its inbuilt Bluetooth module. SFFL repeater to bridge a communication between the lock and the IoT devices. These SFFL repeaters are also powered by batteries.

The major problem associated to power these SFFL repeaters is that we need to setup wires/codes and equipment to coverup these wires/codes in a hotel room and this will not give a good look and feel of the room. This brings about an additional cost.

In view of the aforementioned problems in the existing solutions, there is a need of an efficient and effective method and an apparatus for charging of batteries of electronic accessing devices. In order to solve the problems in the existing solutions, a method and an apparatus are disclosed.

### SUMMARY OF THE INVENTION

Various embodiments of the invention describe a method for wireless charging of batteries of the electronic accessing devices. The method comprises the steps of establishing a first connection between a battery of an accessing device and a receiver. A second connection is established between the accessing device and a transmitter. The transmitter and the receiver are associated with each other. The method further comprises determining a charging status of the battery of the accessing device and communicating the charging status of the battery to the transmitter on determining the charging status of the battery below a predefined threshold value via the second connection. The method also comprises charging the battery of the accessing device with power from the receiver using the first connection, wherein the receiver receives the power from the transmitter over the air.

In an embodiment of the invention, the second connection is a short range communication.

In another embodiment of the invention, the charging status of the battery corresponds to percentage of the total battery remaining for operating the accessing device.

In yet another embodiment of the invention, the accessing device is associated with a locker, a premises, a vehicle, a keybox, real estate iboxes, or padlocks.

In still another embodiment of the invention, the receiver is integrated with the accessing device.

In another embodiment of the invention, the power is received over the air by the receiver using radio frequency (RF) waves.

In yet another embodiment of the invention, multiple accessing devices are charged using the transmitter. The priority of charging the multiple accessing devices is based on the charging status of each of the multiple accessing device.

In still another embodiment of the invention, the charging status of the battery communicated to the transmitter includes the power requirements of the battery of the accessing device.

In another embodiment of the invention, the receiver uses a photovoltaic cell to convert the RF waves received from the transmitter to electrical power.

In yet another different embodiment of the invention, the receiver is present within a predefined range of the transmitter for charging the battery.

In an embodiment of the invention, the predefined range of the transmitter for charging the battery is up to 15 feet.

In another embodiment of the invention, the accessing device is configured to communicate with one or more devices via repeaters, wherein the transmitter is configured to charge the repeater by transferring power to a receiver associated with the repeater.

In a different embodiment of the invention, an apparatus is disclosed for wireless charging of batteries of the electronic accessing devices. The accessing device comprises a connection unit to establish a first connection between a battery of an accessing device and a receiver and a determination unit to determine a status of a battery of the accessing device. The accessing device further comprises a communication unit to establish a second connection between the accessing device and a transmitter. The transmitter and the receiver are associated with each other. The communication unit is configured to communicate the charging status of the battery to the transmitter on determining the charging status of the battery below a predefined threshold value via the second connection. The accessing unit also comprises a connection unit configured to receive the power from the receiver to charge the battery, wherein the receiver receives the power for charging the battery from the transmitter.

In another embodiment of the invention, the charging status of the battery corresponds to percentage of the total battery remaining for operating the accessing device.

In yet another embodiment of the invention, the receiver is integrated with the accessing device.

In still another embodiment of the invention, multiple accessing devices are charged using the transmitter, wherein priority of charging the multiple accessing devices is based on the charging status of each of the multiple accessing device.

In another embodiment of the invention, the charging status of the battery communicated to the transmitter includes the power requirements of the battery of the accessing device.

In still another embodiment of the invention, the power is received by the receiver over the air using radio frequency (RF) waves, wherein the receiver uses a photovoltaic cell to convert the RF waves received from the transmitter to electrical power.

In another embodiment of the invention, the receiver is present within a predefined range of the transmitter for charging the battery.

In yet another different embodiment of the invention, the accessing device is configured to communicate with one or more devices via repeaters, the transmitter is configured to charge each repeater by transferring power to a receiver of each repeater.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Other aspects, advantages, and salient features of the invention will become apparent to those skilled in the art from the following detailed description, which taken in conjunction with the annexed drawings, discloses exemplary embodiments of the invention.

### BRIEF DESCRIPTION OF THE DRAWINGS

FIG. 1 depicts an exemplary system architecture according to an exemplary embodiment of the invention.

FIG. 2 depicts connection between receiver and transmitter according to an exemplary embodiment of the invention.

FIG. 3 depicts a block diagram of different components in an accessing device according to an exemplary embodiment of the invention.

FIG. 4 depicts an exemplary flowchart illustrating a method to perform the invention according to an exemplary embodiment of the invention.

Corresponding reference numerals indicate corresponding parts throughout the drawings.

### DETAILED DESCRIPTION OF THE INVENTION

Described herein is the technology with a method and an apparatus for wireless charging of batteries of the electronic accessing devices. The electronic accessing device may be integrated with a receiver for wirelessly charging status of a battery associated with an accessing device. If the battery of the accessing device reaches below a predefined threshold value, the charging status of the battery is communicated to a transmitter connected to a power source. The transmitter sends the power to the receiver which then communicates with the battery for charging. In an embodiment of the invention, the accessing device may be, but is not limited to, an electronic lock, a smart lock, electro-mechanical lock, a knob, a latch, a fastener or any other such device well known in the art that needs power to operate and is able to communicate through short communication network. Further, the lock may be associated with a premises, a locker, a key-box or a vehicle. The lock or accessing device may also be referred as electronic key device. The premises may be a room, a hall, a meeting room, a lecture room, a conference hall, a building, a floor or any such space known in the art where a lock can be installed for gaining access by a user.

In an embodiment of the invention, the battery may be, but is not limited to, a Lithium-ion (Li-ion) battery, a Nickel Cadmium (Ni—Cd) battery, a Nickel Metal Hydride (Ni-MH) battery, a Lead-Acid battery or any other rechargeable battery obvious to a person skilled in the art.

In an embodiment of the invention, the receiver may communicate with the transmitter over air through short range communication for wireless charging of the batteries. The receiver may be, but is not limited to, Direct-Conversion receiver, Super heterodyne receiver, Dual Conversion Super heterodyne receiver, RF sampling receiver or any other receiver obvious to a person skilled in the art.

In an embodiment of the invention, the transmitter may be connected to a power source. The transmitter may also communicate with the receiver over air through short range communication for wireless charging of the batteries. Such transmitters are well known in the art and may include, but is not limited to, Amplitude Modulation (AM) transmitter, Frequency Modulation (FM) transmitter, Single Side-Band (SSB) modulation transmitter, Direct Conversion transmitter or Super heterodyne transmitter.

In an embodiment of the invention, the power may be, through a passive device, an active device, a resistive circuit, an alternating current, a direct current or any other such means of power well known in the art. The power from the circuit is then converted into electromagnetic power.

It is noted that an electromagnetic energy is transferred over the air to a short distance which is coupled with a receiver. The electromagnetic energy thus received by the receiver is collected or stored and is used in further applications. In an embodiment of the invention, the electromagnetic energy used to transmit the power from the transmitter to the receiver is a radio wave or radio frequency wave.

In an embodiment of the invention, the repeater may be a local repeater, a remote repeater, a wireless repeater or any other such repeater well known in the art that enables extension of the coverage of a signal. The repeaters may also be digital or analog in nature. The repeater also comprises a receiver corresponding to the transmitter for charging a battery. In an embodiment of the invention, the receiver associated with the repeater may also be discoverable and may be charged wirelessly by the transmitter.

In an embodiment of the invention, the short range communication may include a personal area network such as a mesh network, a Bluetooth network, a Wi-Fi network, a near-field network, a ZigBee network or any such network well known in the art.

Throughout the specification, reference numeral 204 depicts an accessing device or a repeater. The reference numerals 204a, 204b, 204c, 204e and 204f may be considered as one or more accessing devices. Similarly, the reference numerals 204f and 204g may be considered as one or more repeaters. The repeaters may be Small Form Factor Lock or SFFL repeaters which have the functionality to assist in transmission of signals between the devices via a short range communication, such as Bluetooth when the distance between the devices is more than a normal range of the short range communication. For example, if the distance between the devices in communication via Bluetooth is 20 feet, then a repeater may be needed between the devices to transmit the signals between the devices. In general, the range of communication via Bluetooth is 15 feet.

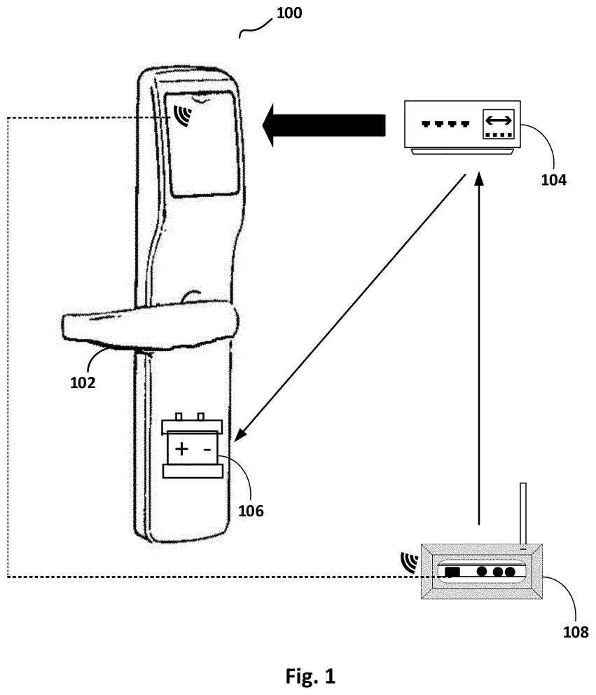

FIG. 1 depicts an exemplary system architecture 100 for wireless charging of batteries of the electronic accessing devices. The electronic accessing device (for instance, lock) 102 may include a rechargeable battery 106. A receiver 104 may be coupled or integrated with the accessing device 102. The receiver 104 may be present within a predefined range of a transmitter 108 for charging the battery 106. A first connection may be established between the battery 106 of an accessing device 102 and the receiver 104. A second connection may be established between the accessing device 102 and the transmitter 108. The second connection may be a short range communication (for e.g, Bluetooth). The receiver 104 and the transmitter 108 are associated with each other. That is, the transmitter and the receiver are complimentary in nature and may be frequency matched as known in the art.

The accessing device monitors the charging status of the associated battery. When the charging status of the battery 106 reaches below a predefined threshold value, the charging status is communicated to the transmitter 108 over the second connection. The charging status of the battery 106 corresponds to a percentage of the total battery remaining for operating the accessing device 102 or it may be amount of battery consumed since last charging. The charging status of the battery may be communicated automatically when the battery reaches below a predefined threshold. On receiving the charging status of the battery 106, the transmitter 108 determines the power required by the battery to get charged. Accordingly, the transmitter schedules the power to be supplied to the receiver. The power may be transmitted from the transmitter 108 to the receiver 104 through the second connection. The transmitter 108 and the receiver 104 are present within the predefined range for appropriate transmission of power. The power may be received by the receiver 104 over the air using radio frequency (RF) waves. The power may be transmitted using a straight narrow beam using microwaves. According to an exemplary embodiment, scalable multiple transmitters may be combined to increase coverage and power. The receiver 104 may use a photovoltaic cell to convert the RF waves received from the transmitter 108 to electrical power. The electrical power thus converted may be used by the receiver 104 to charge the battery 106 associated with the accessing device 102.

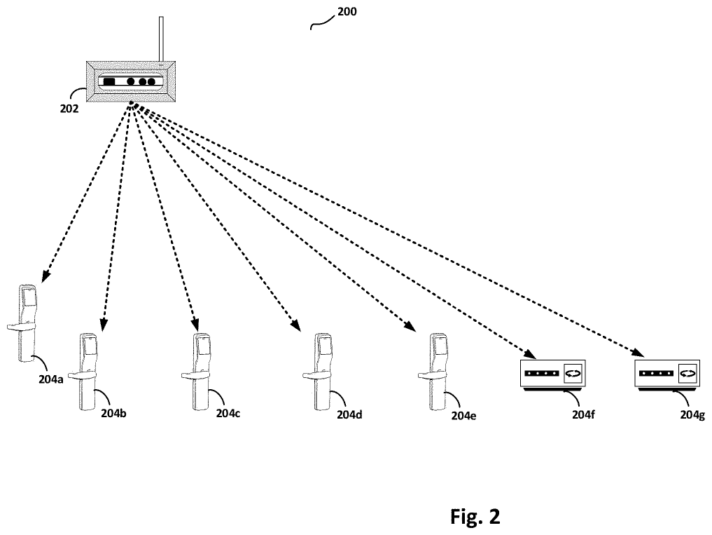

FIG. 2 depicts connection between the receivers associated with the accessing devices 204a-204g and a transmitter 202 according to an exemplary embodiment of the invention. According to an embodiment of the invention, a single transmitter 202 may be able to charge the batteries associated with one or more accessing devices 204a-204g. The scheduling of power to one or more accessing devices 204a-204g may be based on priority. The priority of charging the batteries of the multiple accessing devices is based on the charging status of each of the batteries of the multiple accessing device 204a-204g. For instance, there may be seven accessing devices 204a-204g as depicted in FIG. 2. The predefined threshold value for determining the charging status of the battery may be 30%, i.e., 30% of the total battery may be remaining for operating the accessing device 204. Accordingly, the batteries associated with each of the accessing devices 204a-204g may have less than 30% battery. Assuming two of the accessing devices 204a-204b may be having 25% battery; two of the accessing devices 204d-204g may be having around 20% battery and the remaining three accessing devices-204c, 204e and 204f may be having less than 15% battery. In such a scenario, the one or more accessing devices (204c, 204e and 2040 having the lowest battery may be charged first followed by the accessing devices (204d and 204g) that may have comparatively higher battery. Moreover, when the batteries of the multiple accessing devices 204a-204g are being charged, the transmitter 202 may be configured to charge the batteries of multiple accessing devices 204a-204g upto a predetermined level above the pretermined threshold such that all the multiple devices are charged sufficiently in a given time. In an embodiment of the invention, the wireless charging by the transmitter for multiple accessing devices may be scheduled as charging battery of one accessing device at a time.

Alternatively, the batteries of the multiple accessing devices may be charged in different time slots. The batteries of the multiple accessing devices may also be charged simultaneously. Further, as discussed above the transmitter and the receiver must be within the predefined range for transfer of power from the transmitter to the receiver.

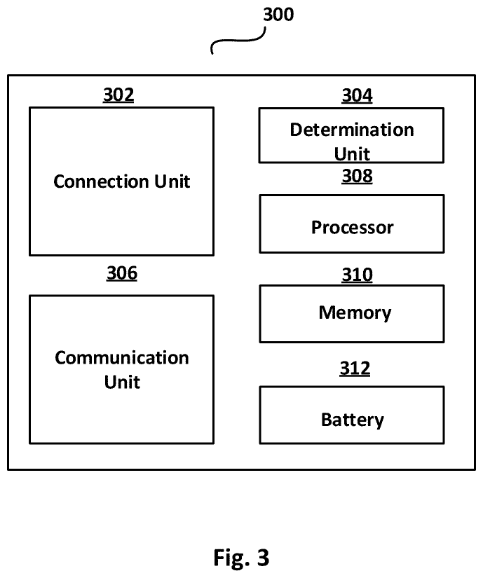

FIG. 3 depicts a block diagram of different components in an accessing device 300 according to an exemplary embodiment of the invention. The accessing device may comprise of, but is not limited to, a connection unit 302, a determination unit 304, a communication unit 306, a processor 308, a memory 310 and a battery 312. The connection unit 302 may establish a first connection between the battery 312 of an accessing device 300 and a receiver. The determination unit 304 of the accessing device 300 may determine a charging status of the battery 312 of the accessing device 300. The charging status of the battery 312 may correspond to percentage of the total battery remaining for operating the accessing device 300. The charging status of the battery 312 communicated to the transmitter may also include the power requirements of the battery of the accessing device 300. The communication unit 306 may establish a second connection between the accessing device 300 and a transmitter, wherein the receiver and the transmitter are associated with each other and the receiver is present within a predefined range of the transmitter. The communication unit 306 may be further configured to communicate the charging status of the battery to the transmitter on determining that the charging status of the battery reaches below a predefined threshold value via the second connection. The connection unit 302 may be further configured to receive the power from the receiver to charge the battery, wherein the receiver may receive the power for charging the battery from the transmitter. A single transmitter may charge multiple accessing devices, wherein the priority of charging the multiple accessing devices is based on the charging status of battery associated with each of the multiple accessing devices 300. Also, if an accessing device 300 whose battery is to be charged is situated at a distance greater than the range of the transmitter, then repeaters may be used to transmit the power.

The connection unit 302, the determination unit 304, the communication unit 306, and/or the memory 310 may be communicably coupled with the processor 308. It is to be noted that all the units described herein are exemplary and the embodiments of the invention may be achieved by using a single unit having all the features of the units mentioned herein.

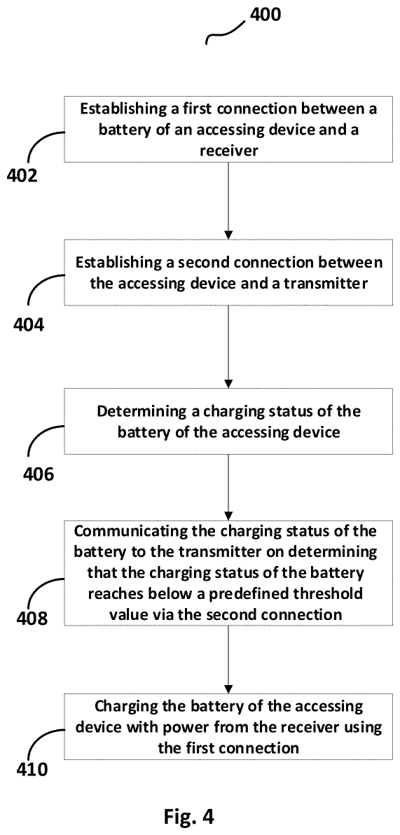

FIG. 4 depicts a flowchart outlining the features of the invention in an exemplary embodiment of the invention. The method flowchart 400 describes a method for wireless charging of batteries of electronic accessing devices. The method step may start at step 402. At step 402, a connection may be established between a battery of an accessing device and a receiver. The connection may be wired or wireless.

At step 404, a second connection may be established between the accessing device and a transmitter over air through short range communication. The transmitter and the receiver are associated with each other.

At step 406, the accessing device may determine a charging status of the battery of the accessing device.

At step 408, the charging status of the battery may be communicated to the transmitter when the charging status of the battery is found to be lower than a predefined threshold value. The said charging status may be communicated through the second connection.

The transmitter then receives power from a standard power source attached to the transmitter.

At step 410, the battery of the accessing device may be charged with the power received by the receiver from the transmitter. The power received from the transmitter by the receiver via the second connection may be used to charge the battery via the first connection. The method step may end at 410.

The present invention is applicable to various fields and industries such as, but not limited to, hospitality industry, real-estate industry, hostels, universities, paying guest accommodations, banks, automobile industry, or any other establishment known in the art where electronic locks or accessing devices may be employed.

The present invention provides the following technical advantages over the existing solutions a) in that the accessing devices leverages operations of its existing Bluetooth modules and communicates with Bluetooth integrated on the transmitter device which. enables seamless wireless charging of electronic accessing devices; b) prevents low battery or dead battery situations; c) eliminates the need of manual opening of locks by technicians using portable programmers; d) saves time and efforts on the part of a technician; e) reduces the complexity of the entire system by circumventing the use of power cables or cords; f) helps power the accessing devices from a distance; g) enables charging of more than one device at a time; h) automatic identification of the charging status of the batteries; and i) transmission of power based on a priority based method taking into consideration the power requirement of each of the devices.

The embodiments of the invention discussed herein are exemplary and various modification and alterations to a person skilled in the art are within the scope of the invention.

The order of execution or performance of the operations in examples of the invention illustrated and described herein is not essential, unless otherwise specified. That is, the operations may be performed in any order, unless otherwise specified, and examples of the invention may include additional or fewer operations than those disclosed herein. For example, it is contemplated that executing or performing a particular operation before, contemporaneously with, or after another operation is within the scope of aspects of the invention.

When introducing elements of aspects of the invention or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.”

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A method comprising:
establishing a first connection between a battery of an accessing device and a receiver and a second connection between the accessing device and a transmitter, the transmitter and the receiver being associated with each other;
determining a charging status of the battery of the accessing device;
communicating the charging status of the battery to the transmitter on determining the charging status of the battery below a predefined threshold value via the second connection; and
charging the battery of the accessing device with power from the receiver using the first connection, wherein the receiver receives the power from the transmitter over the air.

2. The method of claim 1, wherein the second connection is a short range communication.

3. The method of claim 1, wherein the charging status of the battery corresponds to percentage of the total battery remaining for operating the accessing device.

4. The method of claim 1, wherein the accessing device is associated with a locker, a premises, a vehicle or a keybox.

5. The method of claim 1, wherein the receiver is integrated with the accessing device.

6. The method of claim 1, wherein the power is received over the air by the receiver using radio frequency (RF) waves.

7. The method of claim 1, wherein a plurality of accessing devices are charged using the transmitter, wherein priority of charging the plurality of accessing devices is based on the charging status of each of the multiple accessing device.

8. The method of claim 1, wherein the charging status of the battery communicated to the transmitter includes the power requirements of the battery of the accessing device.

9. The method of claim 6, wherein the receiver uses a photovoltaic cell to convert the RF waves received from the transmitter to electrical power.

10. The method of claim 1, wherein the receiver is present within a predefined range of the transmitter for charging the battery.

11. The method of claim 10, wherein the predefined range of the transmitter for charging the battery is up to 15 feet.

12. The method of claim 10, wherein the power between the transmitter and the receiver is transmitted via repeaters if the distance between the transmitter and the receiver is greater than the predefined range.

13. An accessing device comprising:
a connection unit to establish a first connection between a battery of an accessing device and a receiver;
a determination unit to determine a status of a battery of the accessing device;
a communication unit to establish a second connection between the accessing device and a transmitter, the transmitter and the receiver being associated with each other, the communication unit configured to communicate the charging status of the battery to the transmitter on determining the charging status of the battery below a predefined threshold value via the second connection; and
the connection unit further configured to receive the power from the receiver to charge the battery, wherein the receiver receives the power for charging the battery from the transmitter.

14. The accessing device of claim 13, wherein the charging status of the battery corresponds to percentage of the total battery remaining for operating the accessing device.

15. The accessing device of claim 13, wherein the receiver is integrated with the accessing device.

16. The accessing device of claim 13, wherein a plurality of accessing devices are charged using the transmitter, wherein priority of charging the plurality of accessing devices is based on the charging status of each of the multiple accessing device.

17. The accessing device of claim 13, wherein the charging status of the battery communicated to the transmitter includes the power requirements of the battery of the accessing device.

18. The accessing device of claim 13, wherein the power is received by the receiver over the air using radio frequency (RF) waves, wherein the receiver uses a photovoltaic cell to convert the RF waves received from the transmitter to electrical power.

19. The accessing device of claim 13, wherein the receiver is present within a predefined range of the transmitter for charging the battery.

20. The accessing device of claim 19, wherein the power between the transmitter and the receiver is transmitted via repeaters if the distance between the transmitter and the receiver is greater than the predefined range.
